(19) United States
(12) Patent Application Publication
(10) Pub. No.: US 2003/0169968 A1
(43) Pub. Date: Sep. 11, 2003

(54) Photonic signal transmitting device

(76) Inventors: Michael Bazylenko, Eveleigh NSW (AU); Stanislav Petrovich Tarnavskii, Eveleigh NSW (AU)

Correspondence Address: Richard J. Streit, Ladas & Parry, Suite 1200, 224 South Michigan Avenue, Chicago, IL, 60604, US

(21) Appl. No.: 09/900,630

(22) Filed: Jul. 6, 2001

(51) Int. Cl. G02B 6/26; G02B 6/16; G02B 6/18

(52) U.S. Cl. 385/43; 385/50; 385/123; 385/124

(57) ABSTRACT

A photonic signal transmitting device comprising a first waveguide with a first core having a refractive index n₁, and a second waveguide with a second core having an average refractive index n₂>n₁. The second core is formed with a transitional region having a refractive index that increases progressively, and the transitional region of the second core being in contact with the first core, either within or at the peripheral surface of the first core, whereby the refractive index in the device increases progressively from n₁ to n₂ with progression through the first to the second core. A contribution to the increase in refractive index from n₁ to n₂ may effectively be made by tapering the cross-sectional dimensions of the transitional region of the second core.

### FIELD OF THE INVENTION

A photonic signal transmitting device which incorporates a plurality of waveguides having different characteristics and which facilitates coupling of a photonic signal from one to the other or another of the waveguides.

### BACKGROUND OF THE INVENTION

It is known that photonic signals can be transferred from one waveguide to another simply by aligning the ends of the waveguides end to end. This is referred to as “butt coupling” which is adequate where the waveguides being connected have similar cross-sectional dimensions and similar refractive indices. However, if the cross-sectional dimensions and/or refractive indices of the waveguides being connected are dissimilar, optical losses and, possibly, reflections at the interface between the two waveguides will occur. If the mismatch in refractive index and cross-sectional dimensions are sufficiently large, the transfer of a photonic signal from one waveguide to the other will be very inefficient.

It is known that the coupling of dissimilar waveguides can be achieved by tapering one of the waveguides. In this context, reference may be made to U.S. Pat. 5,563,979, dated Oct. 8, 1996, which discloses a planar laser device which comprises an optical coupler for coupling two planar waveguides. Both waveguides are composed of the same type of material (silica- or germanium-based) and have refractive indices which differ by only ˜0.05. One waveguide is doped and has a slightly higher refractive index. This doped, active, waveguide is located upon the other, passive, waveguide and includes a region which is tapered in thickness and/or width which allows for an adiabatic transfer of a single-mode photonic signal.

However, in the case of waveguides that are composed of significantly different types of materials, at least one of two problems may arise. One problem occurs when for example non silica-based materials, such as ferroelectric materials, having relatively large refractive index differences, are coupled with silica-based material. Then, if something approaching adiabatic transfer is required, the tapered region is required to be unacceptably long. This occurs, for example, if a silica waveguide (refractive index ˜1.4) is coupled with a metal-oxide waveguide such as PLZT having a refractive index of ˜2.4.

Another problem may occur when the ideal material processing conditions of the coupling waveguides are themselves different. High processing temperatures may be required to produce a tapered waveguide in a core composed, for example, of a metal-oxide, but these temperatures may be destructive for the underlying silica.

### SUMMARY OF THE INVENTION

The present invention in its broadest sense seeks to resolve at least one of these problems by providing a photonic signal transmitting device which comprises:

a first waveguide comprising a first core having a refractive index n₁, and

a second waveguide comprising a second core having an average refractive index n₂>n₁;

the second core being formed with a transitional region having a refractive index that increases progressively, and the transitional region of the second core being in contact with the first core, whereby the effective refractive index in the device increases progressively with progression from the first to the second core.

The invention may also be defined in terms of a method of forming a photonic signal transmitting device, the method comprising the steps of:

forming a first waveguide comprising a first core having a refractive index n₁, and

forming a second waveguide comprising a second core having an average refractive index n₂>n₁;

the second core being formed with a transitional region having a refractive index that increases progressively, and the transitional region of the second core being in contact with the first core, whereby the effective refractive index of the device increases progressively with progression from the first core through to the second core.

### PREFERRED FEATURES OF THE INVENTION

In one embodiment of the invention the transitional region of the second core is positioned at a peripheral surface of the first core. In an alternative embodiment of the invention at least a portion of the transitional region of the second core is positioned wholly within the first core. The transitional region may be formed such that the refractive index n₂ increases with progression from the first core into the second core in a direction substantially parallel to the direction of signal propagation. The transitional region may alternatively or also be formed such that the refractive index n₂ increases with progression from the first core into the second core in a direction substantially perpendicular to the direction of signal propagation. Furthermore, the transitional region may be formed such that the refractive index n₂ increases two- or three-dimensionally with progression in the direction from the first core into the second core.

In another embodiment of the invention a contribution to the progressive increase in effective refractive index from the first core to the second core may be made by tapering the cross-sectional dimensions of the transitional region of the second core. In this case a photonic signal in progressing into the second waveguide will experience a gradual increase in the effective refractive index due to both the increasing cross-sectional dimensions of the second core and the gradual increase in refractive index n₂ of the second core. Conversely, a photonic signal propagating in the opposite direction through the device (from the second waveguide to the first waveguide) will experience a gradual decrease in the effective refractive index due to the decrease in n₂ and a decrease in the cross-sectional dimensions of the second core.

The tapered region may be tapered 2-dimensionally or 3-dimensionally. That is, the tapered region may be tapered in thickness toward a marginal line. Alternatively, the tapered region may be tapered in width toward a marginal line, or be tapered in both thickness and width toward a point.

When the first core has a greater cross-sectional area than that of the second core, the first core may additionally include a region in which the cross-sectional area of the first core is gradually reduced in the direction toward the second core. This embodiment squeezes a photonic mode before it interacts with the second core and facilitates a further reduction in the distance over which the effective refractive index of the device is required to change.

The second core may comprise a plurality of layers. Each of the layers may itself have a cross-sectional area that is tapered and each successively higher layer (in the direction away from the first core) may have an average refractive index that is higher than that of its preceding (lower) layer so as to create a gradual increase in effective refractive index with progression from the first to the second core. In a preferred embodiment each of the layers is both tapered and has an average refractive index higher than that of its preceding (lower) layer.

In the photonic signal transmitting device the first and the second cores may be separated by an intermediate layer of a material that facilitates fabrication of the device. In the case where the transitional region of the second core is tapered the intermediate layer may comprise a material that can easily be etched, such as amorphous or polycrystalline silicon, to permit the formation of tapered regions with relatively sharp tips.

The first core may be composed of a material based on silica. The second core may be composed substantially of one or more of a silica-based material, silicon-based material, metal-oxide, metal-nitrate and metal-sulphide. More specifically, the second core may be composed substantially of one or more of silicon, Al₂O₃, ZnO and a titanate of Perovskite structure such as PLZT.

Each of the first and second cores may itself be formed from a plurality of subcores.

The first and second waveguides may be planar waveguides. Alternatively, the first arid second waveguides may be optical fibres.

The previously defined method of fabricating the photonic signal transmitting device may comprise shaping the first and second cores by lithographically-defined etching, more specifically photolithographically-defined etching.

The method may also comprise depositing waveguide materials by chemical vapour deposition, more specifically plasma-enhanced chemical vapour deposition. Alternatively, at least some of the waveguide materials may be deposited by sputtering. Advantageously, the sputtering comprises reactive dc sputtering.

The method may also comprise forming the transitional region by varying the oxygen content along the transitional region so as that n₂ increases with progression toward the second core. Alternatively, the method may comprise forming the transitional region by varying a dopant concentration along the transitional region. The variation in oxygen content and/or dopant concentration may be achieved by selectively applying heat to the second core, optionally by masking the resultant zone or zones of the transitional region. When the core is composed of aluminium oxide, the dopant may comprise fluorine.

Preferred embodiments of the photonic signal transmitting device will now be described, by way of example only, with reference to the accompanying drawings.

### BRIEF DESCRIPTION OF THE DRAWINGS

In the drawings:

FIG. 1 shows a cross-sectional diagrammatic view of a first embodiment of cores of the device with a transitional region of the second core overlying a first core,

FIG. 2 shows a diagrammatic plan view of a variation of the first embodiment of the device, when formed with a first core having a narrowed profile,

FIG. 3 shows a cross-sectional diagrammatic view a second embodiment of core portions of the device with the second core being located wholly inside the boundary of the first core,

FIG. 4 shows a cross-sectional view of a variation of the second embodiment of the device with the second core located in part inside the boundary of the first core,

FIGS. 5, 6 and 7 show sectional views of one form of the second embodiment of the invention,

FIG. 8 shows a plan view of the second core as illustrated in FIG. 7,

FIG. 9 shows a plan view of a portion of the second core during formation by a doping process,

FIG. 10 shows a cross-sectional view of the arrangement illustrated in FIG. 9, as viewed in the direction of section plane 10-10,

FIG. 11 shows a plan view of the second core portion as illustrated in FIGS. 9 and 10 following the formation process,

FIGS. 12, 13, 14 and 15 show perspective views of alternative shapes of the second core,

FIG. 16 shows a plan view of a portion of a second core that is similar to that shown in FIG. 12 during formation by a doping process, and

FIG. 17 shows a plan view of the second core portion as illustrated in FIG. 16 following the formation process.

### DETAILED DESCRIPTION OF THE PREFERRED EMBODIMENTS

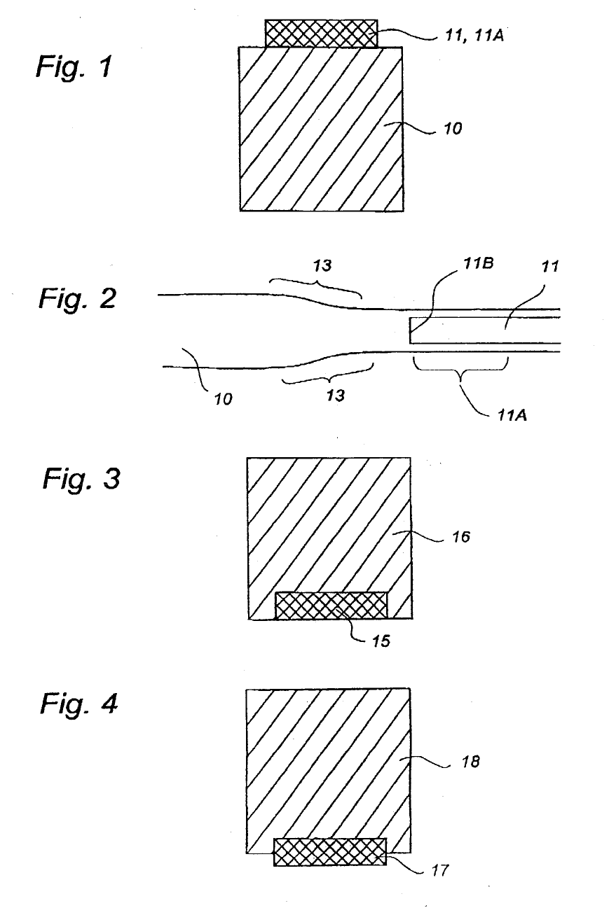

FIG. 1 shows a first embodiment of cores of the device in which the square area represents the cross-sectional area a first core 10 and the rectangular area represents the cross-sectional area of a second core 11. In this embodiment, a transitional region 11A of the second core overlies the first core.

The preferred fabrication method for the embodiment of FIG. 1 involves an initial deposition of a silica-based layer. This layer, for example composed of germanium-doped silica (approx 10 mol % GeO₂), may be deposited on a silica buffer layer (not shown) by plasma-enhanced chemical vapour deposition (PECVD) and formed into the first core 10 using photolithography and etching. A second layer, in this example composed of amorphous silicon, is then deposited onto the first core 10 using PECVD and formed into the second core 11 using photolithography and etching.

The first core 10 may be narrowed in its cross-sectional area in a region 13 adjacent to the second core 11 as shown in FIG. 2.

In the transitional region 11A, the refractive index of the silicon second core 11 gradually decreases with progression along the second core in the direction towards a terminal end 11B where the refractive index of the second core is similar or identical to that of the first core 10. This can be achieved by selectively applying heat to the transitional region so as to progressively increase the oxidation state of the silicon, and thus reduce the refractive index, with progression towards the terminal end 11B. In other words, the composition of the transitional region is SiOₓ where x gradually increases from 0 to 2 with progression toward the terminal end 11B. The variation in oxygen content can be achieved by scanning a laser beam locally in the transitional region.

FIGS. 3 and 4 show two embodiments in which the first core overlies the second core. In FIG. 3 a rectangular area and a square area represent the cross-sectional areas of the second core 15 and the first core 16 respectively. In this example the second core 15 is located wholly inside the boundary of the first core. In the embodiment of FIG. 4 the cross-sectional area of the second core 17 is located in part inside the boundary of the first core 18. For the embodiments shown in FIGS. 3 and 4, the fabrication method would involve initially depositing a layer of material suitable for forming the second core, such as silicon or aluminium oxide. Where the second core comprises amorphous silicon, the core material can be deposited by PECVD. Alternatively, where the second core comprises PLZT or Al₂O₃, the core material can be deposited by sputtering. Specific details of a technique for depositing an aluminium oxide core by sputtering are discussed in co-pending U.S. patent application No. U.S. Ser. No. ______/______ entitled “Planar Waveguide Amplifier” filed on the same date as the present application in the name of Michael Bazylenko and Geoffrey Lester Harding (assigned to Redfern Integrated Optics Pty. Ltd.), the entire disclosure of which is hereby specifically incorporated by cross-reference. The second core is then shaped from the deposited layer using photolithography anid etching. A silica-based layer is subsequently deposited upon the second core and etched into the desired waveguide geometry to form the first core.

In another embodiment the second core projects into the first core such that the axes of light propagation of the first anid second core substantially coincide. This embodiment is described in co-pending U.S. patent application No. U.S. Ser. No. ______/______ entitled “A Photonic Signal Transmitting device” filed on the same day as the present patent application in the names of Michael Bazylenko anid Stanislav Petrovich Tarnavskii (assigned to Redfern Integrated Optics Pty. Ltd.), the entire disclosure of which is specifically incorporated by cross-reference.

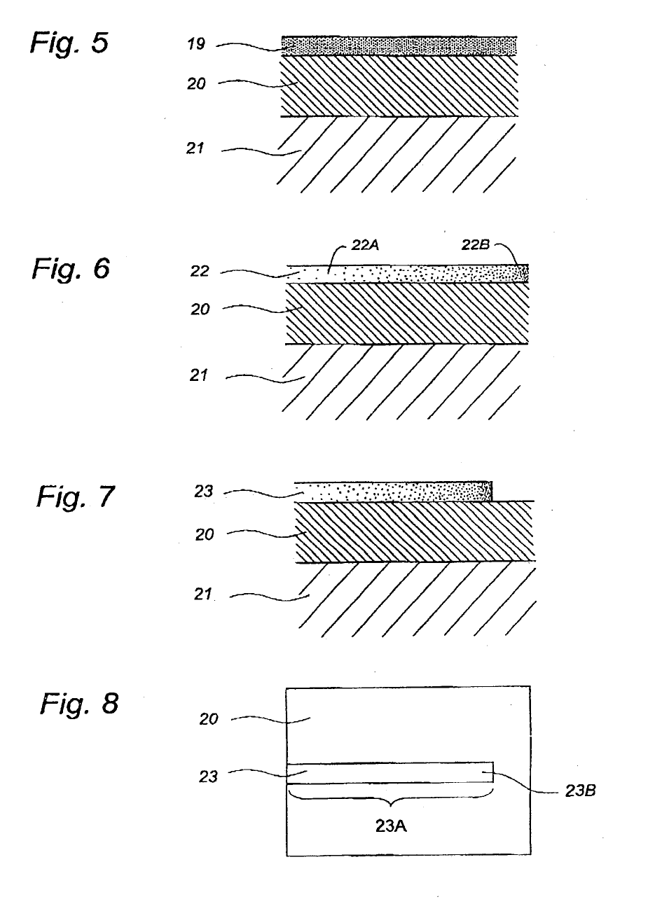

When the second core shown in FIGS. 3 and 4 is formed from amorphous silicon, a transitional region can be formed using the method described with respect to the first embodiment before the first core is deposited i.e. by controlled oxidation of silicon. Alternatively, where the second core comprises a metal oxide such as Al₂O₃, the transitional region can be formed in the second core by incorporating a dopant in the second core and selectively applying heat to the transitional region so as to cause a non-uniform diffusion of the dopant. Again, the second core and transitional region within the second core is prepared before the first core is deposited upon the second core. The steps involved in forming the transitional region according to this process are now described in detail with reference to FIGS. 5 to 8.

In this example, the second core largely comprises aluminium oxide doped with fluorine, which is known to lower the refractive index of aluminium oxide. FIG. 5 shows a fluorine-doped aluminium oxide layer 19 deposited on a silica buffer layer 20 which is in turn formed on a silicon substrate 21. The concentration of fluorine within the aluminium oxide layer 19 is then varied by selectively applying heat to the aluminium oxide layer, resulting in a thermally-processed aluminium oxide layer 22 as shown in FIG. 6. Relatively more heat has been applied to a first zone 22A of the thermally processed aluminium oxide layer 22 than to a second zone 22B, resulting in a concentration gradient of fluorine within the aluminium oxide layer 22. The selective application of heat causes non-uniform diffusion and outgassing of fluorine from the aluminium oxide layer, resulting in a decrease in fluorine content (and a consequential increase in refractive index) with progression from the second zone 22B to the first zone 22A. The thermally-processed aluminium oxide film 22 is then shaped by means of photolithography and etching into a core 23 (see FIGS. 7 and 8) to form a light-guiding channel. In the transitional region 23A of the resultant core 23 the concentration of fluorine increases and the refractive index decreases towards a terminal end 23B of the core 23. A first core (not shown) can then be formed by depositing a silica-based layer over the second core 23 and by using photography and etching to form the silica-based layer into a desired shape.

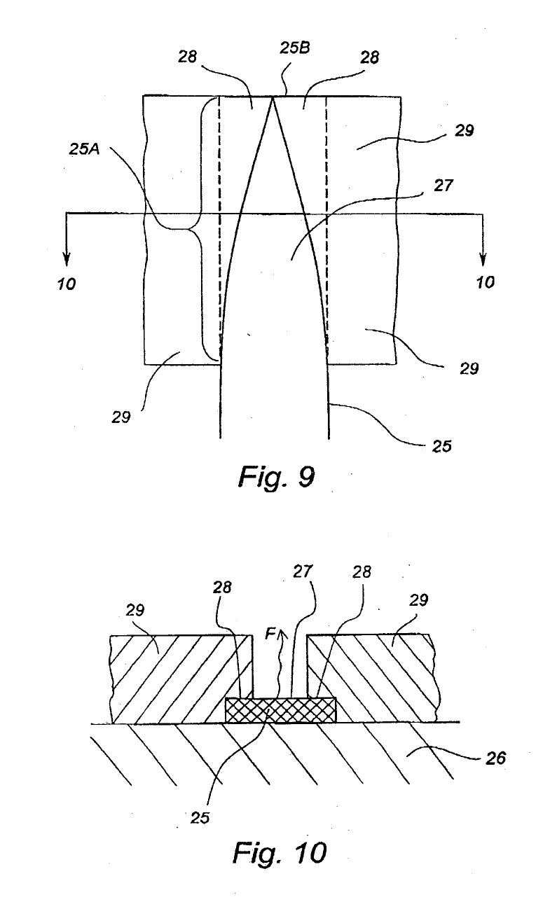

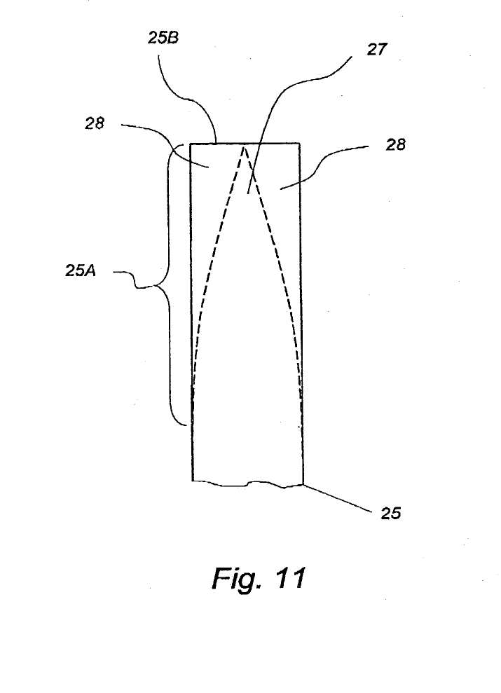

In an alternative approach, as shown in FIGS. 9 to 11, an aluminium oxide core 25 doped with fluorine is first formed on a silica buffer layer 26. A transitional region 25A is formed by masking a portion 28 of the aluminium oxide core 25 such that a first zone 27 of the transitional region 25A is exposed. The mask 29 in this embodiment comprises silica, but could comprise another material. The masked core is then exposed to heat which causes the exposed zone 27 to outgas fluorine, whilst the masked zones 28 are prevented from outgassing fluorine. The resultant structure, as shown in FIG. 11, comprises the first zone 27 composed of aluminium oxide lightly doped with fluorine, and the second zones 28 (which are masked during the heating stage) which are more heavily doped with fluorine. Thus, the average refractive index as measured across the width of the core increases progressively along the length of the core in the direction away from the terminal end 25B of the core.

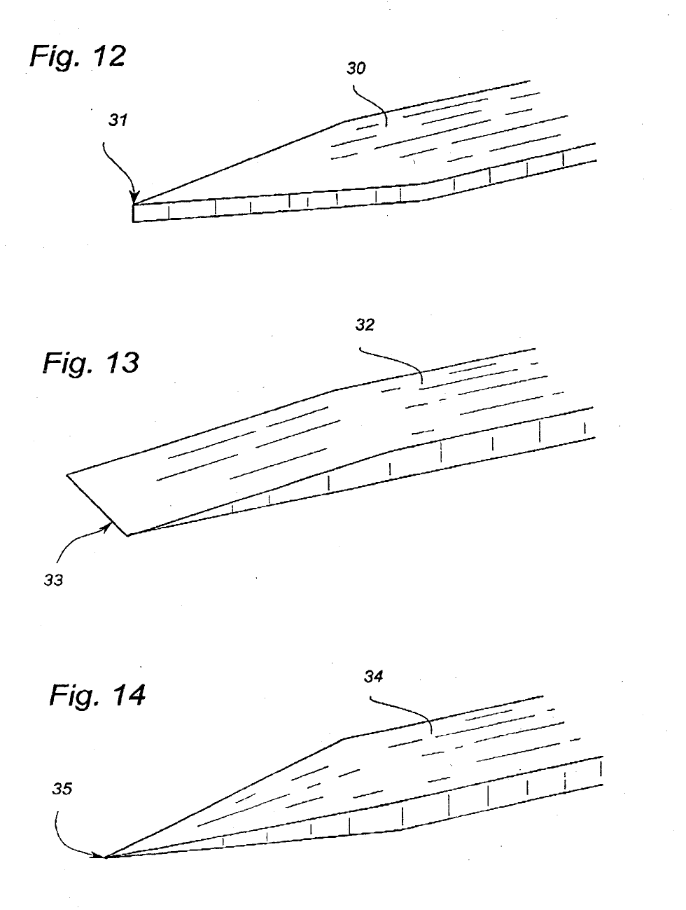

FIGS. 12, 13 and 14 show perspective views of possible configurations of the second core. FIG. 12 shows the second core 30 adiabatically tapered in width toward a vertical marginal line 31. FIG. 13 shows the second core 32 adiabatically tapered in thickness toward a horizontal marginal line 33. FIG. 14 shows another example in which the second core 34 is adiabatically tapered in both thickness and in width substantially toward a point 35.

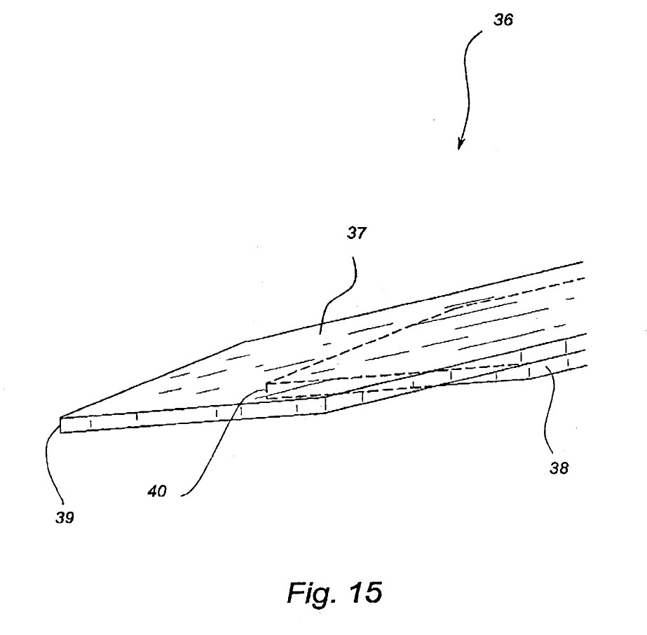

FIG. 15 shows an example in which the second core 36 comprises an inner layer 37 deposited upon an outer layer 38, both of which are individually adiabatically tapered in width towards first and second vertical marginal lines 39 and 40 respectively. These layers may be composed of silicon with different oxygen concentrations or of zinc-oxide (refractive index ˜2) and PLZT (refractive index ˜2.4) and may be fabricated using sputtering techniques This embodiment allows the refractive index across the thickness of the second core to change in steps and is useful where there is a large difference in refractive index between the second core and the first core.

Any one of the second cores shown diagrammatically in FIGS. 12 to 15 may form a part of any one of the examples shown in FIGS. 1 to 4. If the second core is tapered in width, the preferred fabrication method requires photolithographic and etching steps in addition to the respective methods of fabrication relating to the embodiments shown in FIGS. 1 to 4. If the second core is tapered in thickness, the preferred fabrication method requires the following steps in addition to the respective methods of fabrication relating to the embodiments shown in FIGS. 1 to 4. A concentration gradient of etching species is created along the direction of the taper, which can be achieved, for example, by using an appropriate shadow mask containing a suitable pattern. The mask is physically separate from the second core such that there is a gap between the mask and the substrate which determines the length of the tapered region.

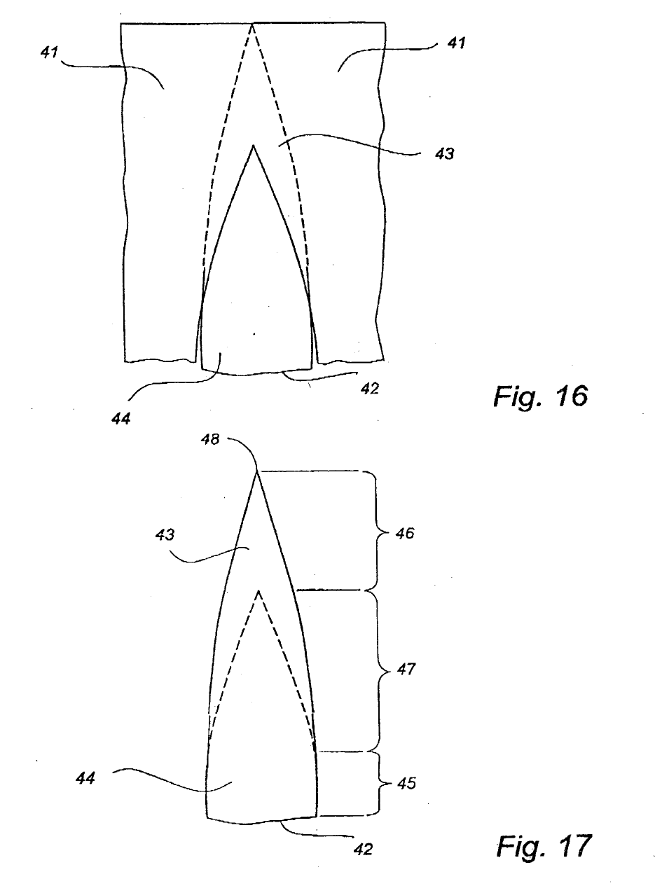

Reference is now made to FIGS. 16 and 17 which show a process in which a mask 41 is deposited over a tapered region of a core 42 so as to cover a leading zone 43 of the tapered region and to expose a central zone 44 of the tapered region. The core comprises fluorine-doped aluminium oxide. The entire structure is exposed to heat, causing fluorine to outgas from the exposed central zone 44. Thus, the refractive index in the central zone 44 increases. The resultant structure (FIG. 17) comprises a zone 45 of constant effective refractive index and a transitional region composed of a first region 46 in which the cross-sectional dimensions of the cores are tapered but in which the material refractive index is constant, and a second region 47 in which the material refractive index is reduced and the cross-sectional dimensions are tapered. Throughout the transitional region, the effective refractive index increases with progression from the terminal end 48 toward the zone of constant refractive index 45.

Although the invention has been described with reference to particular examples, it will be understood that variations and modifications may be made that fall within the scope of the appended claims.

It should also be understood that the above identified U.S. patent application and do not constitute a publication forms a part of the common general knowledge in the art, in Australia or any other country.

We claim:

1. A photonic signal transmitting device which comprises:
a first waveguide comprising a first core having a refractive index n₁, and
a second waveguide comprising a second core having an average refractive index n₂>n₁;
the second core being formed with a transitional region having a refractive index that increases progressively, and the transitional region of the second core being in contact with the first core whereby the effective refractive index of the device increases progressively with progression from the first to the second core.

2. The photonic signal transmitting device as claimed in claim 1 wherein the transitional region of the second core is positioned at a peripheral surface of the first core.

3. The photonic signal transmitting device as claimed in claim 1 wherein at least a portion of the transitional region of the second core is positioned within the first core.

4. The photonic signal transmitting device as claimed in claim 1 wherein the transitional region is formed in a manner such that the refractive index n₂ increases with progression from the first core into the second core in a direction substantially parallel to the direction of signal propagation.

5. The photonic signal transmitting device as claimed in claim 1 wherein the transitional region is formed in a manner such that the refractive index n₂ increases with progression from the first core into the second core in a direction substantially perpendicular to the direction of signal propagation.

6. The photonic signal transmitting device as claimed in claim 1 wherein the transitional region is formed such that the refractive index n₂ increases two- or three-dimensionally with progression from the first core into the second core.

7. The photonic signal transmitting device as claimed in claim 1 wherein the transitional region further comprises a tapered region in which the cross-sectional dimensions of the transitional region of the second core increase with progression into the second core.

8. The photonic signal transmitting device as claimed in claim 7 wherein the tapered region is tapered 2-dimensionally.

9. The photonic signal transmitting device as claimed in claim 7 wherein the tapered region is tapered 3-dimensionally.

10. The photonic signal transmitting device as claimed in claim 7 wherein the tapered region is tapered in thickness toward a marginal line.

11. The photonic signal transmitting device as claimed in claim 7 wherein the tapered region is tapered in width toward a marginal line.

12. The photonic signal transmitting device as claimed in claim 7 wherein the tapered region is tapered in both thickness and width toward a point.

13. The photonic signal transmitting device as claimed in claim 1 wherein the first core additionally includes a region in which the cross-sectional area of the first core is gradually reduced in a direction towards the second core.

14. The photonic signal transmitting device as claimed in claim 1 wherein the second core comprises a plurality of layers.

15. The photonic signal transmitting device as claimed in claim 14 wherein each of the layers has a cross-sectional area that is tapered.

16. The photonic signal transmitting device as claimed in claim 14 wherein each successively higher layer (in the direction away from the first core) has an average refractive index lower than that of its preceding layer so as to create a gradual increase in refractive index with progression into the second core.

17. The photonic signal transmitting device as claimed in claim 14 wherein wherein each of the layers has a cross-sectional area that is tapered and each successively higher layer (in the direction away from the first core) has an average refractive index lower than that of its preceding layer as to create a gradual increase in refractive index with progression into the second core.

18. The photonic signal transmitting device as claimed in claim 1 wherein the first and the second cores are separated by an intermediate layer of a material that facilitates fabrication of the device.

19. The photonic signal transmitting device as claimed in claim 18 wherein the second core comprises a material that facilitates etching.

20. The photonic signal transmitting device as claimed in claim 18 wherein the intermediate layer comprises amorphous silicon.

21. The photonic signal transmitting device as claimed in claim 18 wherein the intermediate layer comprises polycrystalline silicon.

22. The photonic signal transmitting device as claimed in claim 1 wherein the first core is composed of a material based on silica.

23. The photonic signal transmitting device as claimed in claim 1 wherein the second core is composed of at least one of a silica-based material, silicon-based material, metal-oxide, metal-nitrate and metal-sulphide.

24. The photonic signal transmitting device as claimed in claim 1 wherein the second core is composed of at least one of silicon, Al₂O₃, ZnO and a titanate of Perovskite structure such as PLZT.

25. The photonic signal transmitting device as claimed in claim 1 wherein each of the first and second cores is itself formed from a plurality of sub-cores.

26. The photonic signal transmitting device as claimed in claim 1 wherein the first and second waveguides are planar waveguides.

27. The photonic signal transmitting device as claimed in claim 1 wherein the first and second waveguides are optical fibres.

28. A method of forming a photonic signal transmitting device, the method comprising the steps of:
forming a first waveguide comprising a first core having a refractive index n₁, and
forming a second waveguide comprising a second core having an average refractive index n₂>n₁;
the second core being formed with a transitional region having a refractive index that increases progressively, and the transitional region of the second core being in contact with the first core whereby the refractive index of the device increases progressively with progression from the first core through to the second core.

29. The method as claimed in claim 28 wherein at least one of the first and second cores is shaped by lithographically-defined etching.

30. The method as claimed in claim 28 wherein at least one of the first and second cores is deposited by chemical vapour deposition.

31. The method as claimed in claim 28 wherein at least one of the first and second cores is deposited by plasma-enhanced chemical vapour deposition.

32. The method as claimed in claim 28 wherein at least one of the first and second cores is deposited by sputtering.

33. The method as claimed in claim 28 wherein at least one of the first and second cores is deposited by reactive do sputtering.

34. The method as claimed in claim 28 wherein the step of forming the transitional region comprises creating an oxygen content in the second core which varies gradually with progression from the first core through to the second core.

35. The method as claimed in claim 28 wherein the step of forming the transitional region comprises establishing a doped zone in the second core in which a concentration of a dopant varies gradually with progression from the first core through to the second core.

36. The method as claimed in claim 35 wherein establishing the doped zone comprises masking a portion of the transitional region as to expose the zone.

37. The method as claimed in claim 35 wherein the step of forming the transitional region further comprises the selective application of heat.

38. The method as claimed in claim 35 wherein the second core comprises aluminium oxide and the dopant comprises fluorine.
